(19) United States
(12) Patent Application Publication
(10) Pub. No.: US 2023/0266501 A1
(43) Pub. Date: Aug. 24, 2023

(54) Method and System to Spatially Identify Conductive Regions Using Pressure Transience for Characterizing Conductive Fractures and Subsurface Regions

(71) Applicant: ExxonMobil Upstream Research Company, Spring, TX (US)

(72) Inventors: Dalton S. VICE, Spring, TX (US); Kyle B. GUICE, Houston, TX (US); Shreerang S. CHHATRE, The Woodlands, TX (US)

(21) Appl. No.: 18/063,333

(22) Filed: Dec. 8, 2022

Related U.S. Application Data
(60) Provisional application No. 63/268,292, filed on Feb. 21, 2022.

(51) Int. Cl. G01V 99/00; E21B 47/06

(52) U.S. Cl. CPC G01V 99/005; E21B 47/06; E21B 2200/20

(57) ABSTRACT

A methodology for spatially identifying conductive regions using pressure transience for characterizing conductive fractures and subsurface regions is provided. Hydraulic fracturing is utilized to create fractures within a reservoir, thereby increasing fluid permeability of the reservoir and permitting hydrocarbon fluids to flow into a wellbore and subsequently to be produced from the hydrocarbon reservoirs. The geometry, dimensions, and extent of the fractures may significantly impact the production characteristics of the well. However, given that fractures are thousands of feet below the surface, measuring the properties of the fractures can be difficult. In order to characterize the fractures, including determining locations of conductive fractures in the subsurface, sensors are positioned in monitoring wells. Pressure changes are then induced in a well, with the sensors measuring the effect of the pressure changes. In turn, the sensed data may be used in order to characterize the fractures in the subsurface.

### CROSS-REFERENCE TO RELATED APPLICATION

This application claims the benefit of U.S. Provisional Application Ser. No. 63/268,292, entitled “Method and System to Spatially Identify Conductive Regions Using Pressure Transience for Characterizing Conductive Fractures and Subsurface Regions,” filed Feb. 21, 2022, the disclosure of which is hereby incorporated by reference in its entirety.

### FIELD OF THE INVENTION

The present application relates generally to the field of hydrocarbon exploration, development and production. Specifically, the disclosure relates to a methodology for using pressure transience to characterize conductive fractures or subsurface regions.

### BACKGROUND OF THE INVENTION

This section is intended to introduce various aspects of the art, which may be associated with exemplary embodiments of the present disclosure. This discussion is believed to assist in providing a framework to facilitate a better understanding of particular aspects of the present disclosure. Accordingly, it should be understood that this section should be read in this light, and not necessarily as admissions of prior art.

Various well stimulation processes may be used to enhance the effective permeability surrounding a well. One such example of a well stimulation process is hydraulic fracturing, which may be utilized to stimulate low-permeability hydrocarbon reservoirs. See, for example, US Patent Application Publication No. 2021/0088690 A1; US Patent Application Publication No. 2021/0017852 A1; US Patent Application Publication No. 2021/0388712 A1, each of which are incorporated by reference herein. In particular, hydraulic fracturing may be utilized to create a plurality of fractures within the reservoirs, thereby increasing fluid permeability of the reservoirs and/or permitting hydrocarbon fluids to flow into a wellbore and subsequently to be produced from the hydrocarbon reservoirs. For example, the hydraulic fracture process may comprise pumping fluid into the well above a fracture pressure in order to generate fractures that may also interact with the natural fracture to create a fracture network. Then, proppant may be pumped into the well so that at least a portion of the hydraulic and natural fractures will have a conductivity (e.g., permeability) that allows economic production from the well.

### SUMMARY OF THE INVENTION

In one or some embodiments, a computer-implemented method for characterizing at least one of a part of a well or a part of a subsurface is disclosed. The method includes: inducing one or more pressure changes at or in at least one well; sensing data, exterior to the at least one well using at least one sensor, indicative of an effect of the one or more pressure changes; generating, using the data, information indicative of one or more locations where the effect of the one or more pressure changes at the at least one well are reflected quicker than in a surrounding reservoir in order to characterize the at least one of a part of the at least one well or the part of the subsurface; and using the information for hydrocarbon development.

In one or some embodiments, a computer-implemented method for positioning one or more sensors in a monitoring well in a subsurface is disclosed. The method includes: inducing one or more pressure changes at or in at least one well; sensing data, exterior to the at least one well using at least one sensor, indicative of an effect of the one or more pressure changes; generating, using the data, information indicative of one or more locations where the effect of the one or more pressure changes at the at least one well are reflected quicker than in a surrounding reservoir in order to characterize the at least one of a part of the at least one well or the part of the subsurface; determining, based on the information, one or more positions for the one or more sensors; and positioning, based on the one or more positions, the one or more sensors in the monitoring well.

### BRIEF DESCRIPTION OF THE DRAWINGS

The present application is further described in the detailed description which follows, in reference to the noted plurality of drawings by way of non-limiting examples of exemplary implementations, in which like reference numerals represent similar parts throughout the several views of the drawings. In this regard, the appended drawings illustrate only exemplary implementations and are therefore not to be considered limiting of scope, for the disclosure may admit to other equally effective embodiments and applications.

FIG. 1 is a first example of a schematic of a map view of a 2 well system composed of a signal well and a monitor well intersecting the fractured area.

FIG. 2 is a graph of time to pressure response (in days) versus distance from gauge to conductive fracture indicative of a simplified analytical model-based gauge resolution requirements for a given completion efficiency.

FIG. 3 is a second example of a schematic of a map view of a 2 well system composed of a signal well and a monitor well intersecting the fractured area, with a plurality of gauge locations.

FIG. 4 is an illustration of a first example output from an analytical diffusivity model demonstrating the results of the distance solution found in analysis of an internal pilot.

FIG. 5 is an illustration of a second example output from an analytical diffusivity model using published data from a competitor pilot.

FIG. 6 is an example of a flow diagram of obtaining data and generating an analytical model for predicting locations of high conductivity.

FIG. 7 is a diagram of an exemplary computer system that may be utilized to implement the methods described herein.

### DETAILED DESCRIPTION OF THE INVENTION

The methods, devices, systems, and other features discussed below may be embodied in a number of different forms. Not all of the depicted components may be required, however, and some implementations may include additional, different, or fewer components from those expressly described in this disclosure. Variations in the arrangement and type of the components may be made without departing from the spirit or scope of the claims as set forth herein. Further, variations in the processes described, including the addition, deletion, or rearranging and order of logical operations, may be made without departing from the spirit or scope of the claims as set forth herein.

It is to be understood that the present disclosure is not limited to particular devices or methods, which may, of course, vary. It is also to be understood that the terminology used herein is for the purpose of describing particular embodiments only, and is not intended to be limiting. As used herein, the singular forms “a,” “an,” and “the” include singular and plural referents unless the content clearly dictates otherwise. Furthermore, the words “can” and “may” are used throughout this application in a permissive sense (i.e., having the potential to, being able to), not in a mandatory sense (i.e., must). The term “include,” and derivations thereof, mean “including, but not limited to.” The term “coupled” means directly or indirectly connected. The word “exemplary” is used herein to mean “serving as an example, instance, or illustration.” Any aspect described herein as “exemplary” is not necessarily to be construed as preferred or advantageous over other aspects. The term “uniform” means substantially equal for each sub-element, within about ±10% variation.

The term “seismic data” as used herein broadly means any data received and/or recorded as part of the seismic surveying and interpretation process, including displacement, velocity and/or acceleration, pressure and/or rotation, wave reflection, and/or refraction data. “Seismic data” is also intended to include any data (e.g., seismic image, migration image, reverse-time migration image, pre-stack image, partially-stack image, full-stack image, post-stack image or seismic attribute image) or interpretation quantities, including geophysical properties such as one or more of: elastic properties (e.g., P and/or S wave velocity, P-Impedance, S-Impedance, density, attenuation, anisotropy and the like); and porosity, permeability or the like, that the ordinarily skilled artisan at the time of this disclosure will recognize may be inferred or otherwise derived from such data received and/or recorded as part of the seismic surveying and interpretation process. Thus, this disclosure may at times refer to “seismic data and/or data derived therefrom,” or equivalently simply to “seismic data.” Both terms are intended to include both measured/recorded seismic data and such derived data, unless the context clearly indicates that only one or the other is intended. “Seismic data” may also include data derived from traditional seismic (e.g., acoustic) data sets in conjunction with other geophysical data, including, for example, gravity plus seismic; gravity plus electromagnetic plus seismic data, etc. For example, joint-inversion utilizes multiple geophysical data types.

The term “geophysical data” as used herein broadly includes seismic data, as well as other data obtained from non-seismic geophysical methods such as electrical resistivity. In this regard, examples of geophysical data include, but are not limited to, seismic data, gravity surveys, magnetic data, electromagnetic data, well logs, image logs, radar data, or temperature data.

The term “geological features” (interchangeably termed geo-features) as used herein broadly includes attributes associated with a subsurface, such as any one, any combination, or all of: subsurface geological structures (e.g., channels, volcanos, salt bodies, geological bodies, geological layers, etc.); boundaries between subsurface geological structures (e.g., a boundary between geological layers or formations, etc.); or structure details about a subsurface formation (e.g., subsurface horizons, subsurface faults, mineral deposits, bright spots, salt welds, distributions or proportions of geological features (e.g., lithotype proportions, facies relationships, distribution of petrophysical properties within a defined depositional facies), etc.). In this regard, geological features may include one or more subsurface features, such as subsurface fluid features, that may be hydrocarbon indicators (e.g., Direct Hydrocarbon Indicator (DHI)).

The terms “velocity model,” “density model,” “physical property model,” or other similar terms as used herein refer to a numerical representation of parameters for subsurface regions. Generally, the numerical representation includes an array of numbers, typically a 2-D or 3-D array, where each number, which may be called a “model parameter,” is a value of velocity, density, or another physical property in a cell, where a subsurface region has been conceptually divided into discrete cells for computational purposes. For example, the spatial distribution of velocity may be modeled using constant-velocity units (layers) through which ray paths obeying Snell's law can be traced. A 3-D geologic model (particularly a model represented in image form) may be represented in volume elements (voxels), in a similar way that a photograph (or 2-D geologic model) may be represented by picture elements (pixels). Such numerical representations may be shape-based or functional forms in addition to, or in lieu of, cell-based numerical representations.

The term “subsurface model” as used herein refer to a numerical, spatial representation of a specified region or properties in the subsurface.

The term “geologic model” as used herein refer to a subsurface model that is aligned with specified geological feature such as faults and specified horizons.

The term “reservoir model” as used herein refer to a geologic model where a plurality of locations have assigned properties including any one, any combination, or all of rock type, EoD, subtypes of EoD (sub-EoD), porosity, clay volume, permeability, fluid saturations, etc.

For the purpose of the present disclosure, subsurface model, geologic model, and reservoir model are used interchangeably unless denoted otherwise.

As used herein, “hydrocarbon management”, “managing hydrocarbons” or “hydrocarbon resource management” includes any one, any combination, or all of the following: hydrocarbon extraction; hydrocarbon production, (e.g., drilling a well and prospecting for, and/or producing, hydrocarbons using the well; and/or, causing a well to be drilled, e.g., to prospect for hydrocarbons); hydrocarbon exploration; identifying potential hydrocarbon-bearing formations; characterizing hydrocarbon-bearing formations; identifying well locations; determining well injection rates; determining well extraction rates; identifying reservoir connectivity; acquiring, disposing of, and/or abandoning hydrocarbon resources; reviewing prior hydrocarbon management decisions; and any other hydrocarbon-related acts or activities, such activities typically taking place with respect to a subsurface formation. The aforementioned broadly include not only the acts themselves (e.g., extraction, production, drilling a well, etc.), but also or instead the direction and/or causation of such acts (e.g., causing hydrocarbons to be extracted, causing hydrocarbons to be produced, causing a well to be drilled, causing the prospecting of hydrocarbons, etc.). Hydrocarbon management may include reservoir surveillance and/or geophysical optimization. For example, reservoir surveillance data may include, well production rates (how much water, oil, or gas is extracted over time), well injection rates (how much water or CO₂ is injected over time), well pressure history, and time-lapse geophysical data. As another example, geophysical optimization may include a variety of methods geared to find an optimum model (and/or a series of models which orbit the optimum model) that is consistent with observed/measured geophysical data and geologic experience, process, and/or observation.

As used herein, “obtaining” data generally refers to any method or combination of methods of acquiring, collecting, or accessing data, including, for example, directly measuring or sensing a physical property, receiving transmitted data, selecting data from a group of physical sensors, identifying data in a data record, and retrieving data from one or more data libraries.

As used herein, terms such as “continual” and “continuous” generally refer to processes which occur repeatedly over time independent of an external trigger to instigate subsequent repetitions. In some instances, continual processes may repeat in real time, having minimal periods of inactivity between repetitions. In some instances, periods of inactivity may be inherent in the continual process.

If there is any conflict in the usages of a word or term in this specification and one or more patent or other documents that may be incorporated herein by reference, the definitions that are consistent with this specification should be adopted for the purposes of understanding this disclosure.

As discussed in the background, fracking may be an effective well stimulation process. Further, the geometry, dimensions, and/or extent of the hydraulic fractures that are associated with a given hydrocarbon well may have a significant impact on the production characteristics of the hydrocarbon well. With this in mind, knowledge of the geometry, dimensions, and/or extent of the hydraulic fractures may guide completion stage and/or well spacing, may help to mitigate environmental concerns, and/or may be utilized to improve the accuracy of numeric models of hydrocarbon wells. However, hydraulic fractures generally are thousands, if not tens of thousands, of feet below the surface. Thus, their geometric properties may not be directly and effectively measured. Specifically, the hydraulic fractures and proppant transport may be difficult to model and therefore neither the fracture network nor the extent to which portion of the fractures are propped may be a priori predicted. As such, the lack of methodologies to locate areas of increased conductivity generates uncertainty that may challenge well economics.

Thus, in one or some embodiments, a method and system are disclosed that provides a posterior characterization of at least a part of the well (such as fractures associated with the well) and/or at least one aspect of the subsurface (such as a part of the subsurface that is highly conductive). Pressure changes may be induced in a well, with data indicative of the effect of the pressure changes being sensed by one or more sensors positioned apart from the well (such as one or more sensors positioned in a monitoring well). As such, a pressure change induced in a respective well may assist in characterizing one or more regions that are hydraulically connected to the respective well. In particular, fractures from one or more wells may be characterized in the event that the one or more wells are hydraulically connected to the respective well in which the pressure change was induced.

In a first specific embodiment, the data may be analyzed in order to characterize at least one aspect of the fracture(s) associated with the well, such as the conductivity of the fracture (e.g., whether the fracture is sufficiently open through which fluid may flow). In particular, the methodology may sense data, such as pressure (e.g., pressure time series sensed at a plurality of gauges), and may estimate one or more variables (e.g., permeability and/or porosity of the subsurface may be estimated, such as a range of estimated values, using subsurface modeling; estimate of distances between fractures), and may curve fit the data (e.g., iteratively solve an inverse problem whereby the distances between the fractures (that are sufficiently conductive to generate the sensed pressure response) are updated in order to fit the data). In turn, the results of the curve fitting may be output in one of several ways. In one way, the distance of gauges from fractures may be represented by a distribution. In this way, the methodology may characterize the conductive fractures. Responsive to determining the conductivity of the fractures, one or both of the fracture completion or the selection of spacing between wells may be modified, as discussed below.

Conductivity may be quantified in one of several ways. In one way, responsive to determining that there is not a predetermined amount of flow, a solution may be generated as part of the algorithm that can be a vector field or scalar value. For example, within a diffusivity solution, various parameters may be defined as a vector field or scalar value (e.g., the values may be dynamic or static; fluid flowing may be static or dynamic with regard to time). In generating a solution to the diffusivity problem, inputs to the diffusivity problem may include the sensed pressure profile and values/ranges of the one or more variables (e.g., as discussed above, ranges for any one, any combination, or all of permeability, porosity, or distance). The diffusivity solution may include the values for the one or more variables that comport with the sensed pressure profile. In this way, the conductivity (as represented by the diffusivity solution) may be characterized based on whether a respective region is sufficiently conductive to transmit statistically significant volumes (e.g., with respect to the total volumes from a given well).

More specifically, one or more aspects of the conductive portion(s) of the fracture(s) may be characterized, such as one or both of location of the fracture(s) (e.g., the absolute location of a respective fracture and/or distance between fractures) or length of the conductive portion(s) of the fracture(s). Thus, in one aspect, the method and system may estimate the locations where a stimulation process (e.g., hydraulic fracture process) results in a change in conductivity, such as an increase of conductivity, in the reservoir (e.g., propped fractures in case of the hydraulic fracture process). This is in contrast to other methodologies, which fail to give meaningful views of fractures, such as the location and one or more dimensions of the conductive fracture.

In a second specific embodiment, the data may be analyzed in order to characterize at least one aspect of the subsurface, such as portion(s) of the subsurface (e.g., one or more locations or sections) wherein the effect of the pressure change(s) in the well are reflected quicker than in the surrounding reservoir. For example, the portion(s) of the subsurface may have conductivity that is larger than a predetermined amount, thereby indicating, for example, layer(s) or the like that reflect the pressure change(s) quicker than in surrounding rock in the subsurface (e.g., locate thin layers of sand between shales in conventional reservoirs).

In one or some embodiments, the method and system may use an analytical model (alternatively term an analytical pressure model or an analytical diffusivity model) that may be based on a hydraulic diffusivity and may be configured to predict locations of high conductivity connected to the well (e.g., fractures and/or sections in the subsurface) from the interpretation of the observed pressure variations at several monitored pressure gauges. Various metrics for conductivity may be used in order to identify a predetermined conductivity magnitude of a conductive region that is generating pressure change in the reservoir. Further, the methodology may perform any one, any combination, or all of: scaling of cluster efficiency of conductive fractures with distance from a hydraulically fractured well; identify changes in fracture conductivity with time and/or distance in a hydraulically fractured well; or identify spatial distribution of flux rates, indicating fracture conductivity. In this way, the methodology may identify spatial/temporal area(s) in which a localized flow regime is present. The methodology may use a variety of ways to identify a localized flow regime. In one embodiment, the linear flow regime may be identified when the flow deviates toward pseudo-steady state or any other flow regime. In particular, a change from the linear flow regime/transient flow regime to the pseudo steady state indicates that the transient pressures have touched each other (e.g., symmetry point), and in turn indicating the distances between fractures. In turn, identifying the localized areas with a given flow regime enables quantification of area(s) that drive macroscopic well flow regimes.

Further, as discussed below, the methodology may identify one or more subsurface scenarios. For example, the methodology may identify diffusivity parameterization scenarios in solution space for a given parameter space, model design, and pressure measurements. Such knowledge of parameterization generated may reduce uncertainty in static properties of reservoir simulations. In this way, based on the output from the models, the subsurface may be characterized, which may in turn be used to reduce uncertainty in an alternate application, such as reservoir simulation.

In addition, pressure transience may be mapped during transient periods and may be used to generate an indicator of the conductivity (e.g., a distance to a closest conductive fracture), as discussed below. Once distances to the closest fractures are mapped, the methodology may analyze pressure drop to determine if there is evidence of interference from another fracture.

In one or some embodiments, the analytical model may perform a mathematical optimization (e.g., a nonlinear mathematical optimization) to the pressure time series gathered at the gauges by utilizing spatial distance from conductive fractures and/or reservoir input as independent variables. To accomplish the match and generate the pressure signatures that best represent the data, the methodology may generate a solution, such as via non-linear mathematical optimization, to reduce or minimize the error in an objective function. Various non-linear mathematical optimization methodologies are contemplated, such as by using: a metaheuristic algorithm; a non-exact algorithm that employs a stochastic process to converge to an approximate global minimum; an algorithm based on differential evolution; particle swarm optimization; simulated annealing; or the like. The methodology may then iteratively reduce or minimize an error reduction objective function to match the pressure and distances to conductive fractures with the data set used for the match. Further, the analytical model may be generalized to interpret the pressure signal from multiple fractures at multiple gauges, which may improve the numerical stability.

In one or some embodiments, to address the uncertainty in optimization of resource recovery, the output from the analytical model may comprise a spatially-distributed view, such as a spatially-distributed view of the conductive fracture network and/or a spatially-distributed view of layers/locations of conductive portions of the subsurface. In turn, the spatially-distributed view may be used as part of hydrocarbon management. As one example, the spatially-distributed view of the conductive fracture network may improve the design assessment of a given development plan (e.g., for a different area in the same field where the data was obtained or for a different field similar to the field where the data was obtained). In particular, completions of fractures may be modified in one or more ways, such as any one, any combination, or all of: the type and/or amount of proppant; the number of clusters and/or the number of stages; the stage spacing; the amount of fluid used in completion; or the type given the of fluid used in completion. In this way, the spatially-distributed view, which may be indicative of length and/or height of conductive fractures, may be used in hydrocarbon management. This is unlike typical methodologies, which may be unable to identify conductive fractures in a quantitative or measurable manner. Merely by way of example, responsive to determining that a hydraulic fracturing process creates 2000 feet of fractures, but that only 300 feet of created fractures are conductive (e.g., conductive with proppant) and able to conduct oil, one or both of the completions (e.g., change completions so that more of the 2000 feet of fractures is conductive) and/or the well spacing (e.g., place well spacing at 300 feet apart in a different section of the same field) may be modified. Thus, the spatially-distributed view may: (1) optimize the well spacing; and/or (2) determine an effective completion strategy.

Alternatively, or in addition, the spatially-distributed view may provide supporting data to recommend an improved or optimized development plan based on the output generated by the faster traveling pressure signals (e.g., weeks to months) before production diagnostics have delivered any insight (e.g., months to years). In particular, analysis of the wells is centered on production from the wells rather than pressure in the wells. As such, analysis of production (which is dependent on speed of transport of molecules) is much longer than analysis of pressure (which is dependent on the speed of the pressure transient). Thus, the ability to measure the pressure over a smaller time frame (on the order of months versus a year) enable accelerating decisions to change the hydrocarbon extraction (e.g., change fracture completions and/or well spacing).

As another example, the spatially-distributed view of layers/locations of conductive portions of the subsurface may improve hydrocarbon extraction targeted to the identified layers/locations of conductive portions of the subsurface. In particular, the placement of the wells and/or the completions may be modified based on the spatially-distributed view of layers/locations of conductive portions of the subsurface, as discussed above.

In this way, the methodology may identify location(s) of conductive fractures (such as identification of spatial area with infinite conductivity fractures) that surround a gauge (e.g., spatial distribution along a wellbore and/or how far the fractures extend perpendicular to the wellbore), which may be used in optimal well spacing for depletion of hydraulically fractured unconventional reservoirs. Alternatively, or in addition, the methodology may identify one or more regions where there is not enhanced conductivity or enhanced conductivity is not nearby (e.g., the spatial area(s) without conductive fractures).

The methodology may derive one or more benefits. First, the methodology may be significantly faster (e.g., a few hours to implement and run) than a typical reservoir simulation based approach (which may take months for history match and prediction). Further, the analytical model may be used as a generalized tool and applicable in a variety of reservoirs with appropriate conditions that meet the assumptions of the analytical model with the correct data.

Second, the methodology only requires basic knowledge of reservoir properties and pressure drop associated with signal well compared to other methodologies that require rate data such as RTA/PTA and high fidelity simulation. Third, the methodology may be generalized and used with any set of pressure time series data to identify highly conductive regions and does not need to intersect them like fiber or other wellbore measurements. Fourth, the methodology may generate a unique solution in determining distance to a conductive fracture from a measurement device. Current techniques require tradeoffs, such as drilling a well after hydraulic fracturing to find conductive fractures, potentially missing fracture diagnostic data, or sacrificing resolution by attempting measurements in a well drilled before fracturing.

Fifth, the methodology, using the analytical model, is the only known methodology to spatially identify conductive fractures utilizing the pressure signal to measure a distance to a fracture that is truly conductive and contributing to production during well drawdown. Current state of the art techniques have limited ability to locate conductive fractures. For example, a wellbore fiber cannot find conductive fractures, and core can only make observations on the sampled area. Thus, other methods may provide an estimate of the wetted fracture locations but cannot identify the location where the proppant effectively filled the fractures thus enabling reservoir depletion

In one or some embodiments, a method and system for placement of one or more pressure gauges is disclosed. In one embodiment, the method and system for placement of one or more pressure gauges may be used in combination with the method and system for posterior characterization of at least a part of the well (such as fractures associated with the well) and/or at least one aspect of the subsurface (e.g., obtaining data for the posterior characterization based on the methodology for pressure gauge placement). Alternatively, the method and system for placement of one or more pressure gauges may be used separately from the method and system for posterior characterization of at least a part of the well.

Thus, in one aspect, responsive to determining one or more aspects of the subsurface (e.g., one or both of rock properties or fluid properties), the methodology may determine the recommended or ideal gauge locations to evaluate the efficiency of a well stimulation process. In particular, the methodology may: determine, for a given system of wells with given rock and fluid properties, the number of pressure gauges needed to sense pressure within a designated period of time.

Determining the ideal gauge locations may be used in a variety of contexts, such as prior to configuring the monitoring well(s) and the producing well(s). In such an instance, various criteria may be set, such as the time frame desired in which to sense the pressure signal (thereby obtaining the pressure data within the desired time frame). Once the time frame is set, the locations of the pressure gauges and/or the appropriate spacing for the pressure gauges may be determined (such as locations inside and/or outside the monitor well). In this way, the methodology may identify the gauge resolution and placement recommendations so that the monitor well(s) may actively detect conductive fractures in the desired time frame (e.g., generating a priori knowledge of pressure measurement resolution requirements to quantify expected conductive regions). Thus, the methodology may be used to bound the number of pressure gauges needed to sense pressure depletion for a given system of wells with given rock and fluid properties compared to fiber optic based methodologies that do not describe depletion.

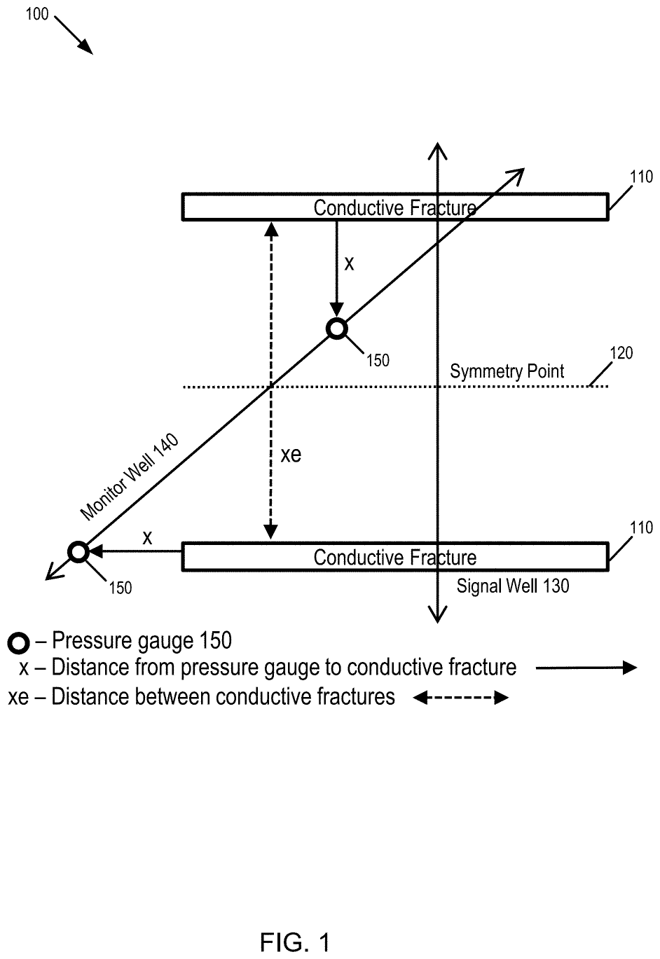

Referring to the figures, FIG. 1 is a first example of a schematic 100 of a map view of a 20 well system composed of a signal well 130 and a monitor well 140 intersecting the fractured area. FIG. 1 is merely for illustration purposes. Greater numbers of signal wells and/or monitor wells are contemplated. The signal well 130 may be at various stages of hydrocarbon extraction, such as primary depletion. In one or some embodiments, sensors, such as from one or more pressure gauges 150, may be used to generate an analytical model, which may be configured to predict pressure propagation from the signal well's conductive fractures 110 based on data generated by the one or more pressure gauges 150. In particular, the analytical model may be configured to map pressure transients and extrapolate distances from conductive fractures 110 of the signal well 130. Pressure transients may be generated in one of several ways. In one way, the pressure transients may be generated during production. In another way, pressure transients may be generated by injecting fluid(s) into the well.

FIG. 1 further illustrates the symmetry point 120 at which the conductive fractures 110 are equidistant, x as the distance from the pressure gauge 150 to the closest conductive fracture 110 and xe as the distance between conductive fractures 110. In one or some embodiments, distances may be determined between fracture tips. For example, two producing wells may have hydraulic fractures, with pressure propagating between the respective fracture tips (as opposed to pressure propagating between a producing well and a monitoring well).

As shown in FIG. 1, the pressure gauges 150 are located in or relative to the monitor well 140. Alternatively, the pressure gauges 150 may be located outside of the monitor well 140, such as located in the producing well(s) (e.g., signal well 130). Further, in one embodiment, the monitor well(s), in which the pressure gauge(s) are placed, may comprise non-producing well(s) that are proximate to the producing well(s). Alternatively, the monitor well(s), in which the pressure gauge(s) are placed, may comprise producing well(s) that are in the same well pad as the producing well in which the pressure change is initiated.

The analytical model may be used in a variety of well layouts. Merely by way of example, to implement the analytical model for a simple system of one well and spatially arranged gauges, a time series of pressure drops at the points of measurement may be obtained. Alternatively, the analytical model may be applied for multi-well models. In this regard, any discussion herein regarding the data obtained or the analytical model generated by the data may be applied either to a single-well system or a multi-well system (e.g., at least a two-well system; at least a three-well system; at least a four-well system; at least a five-well system; at least a six-well system; etc.). For the model to give insights in the accelerated time frame to improve or optimize depletion, the pressure gauges may be selected with certain aspects (e.g., a particular resolution) and/or a particular placement or location in the monitor well 140.

Thus, in one or some embodiments, a pressure change may be induced in a well, such as signal well 130. It is noted that the time for the pressure change to travel from the well to the fracture is small relative to the time for the pressure change to travel through the subsurface to the pressure gauge 150. In this regard, in one or some embodiments, it is assumed that the time for the pressure change to travel from the well to the fracture is negligible (e.g., nearly instantaneous) so that the overall time measured (from the time that the pressure change is induced in the well to the time that the pressure gauge sensing the pressure change) is entirely attributed to the time that the pressure change travels from the fracture to the pressure change.

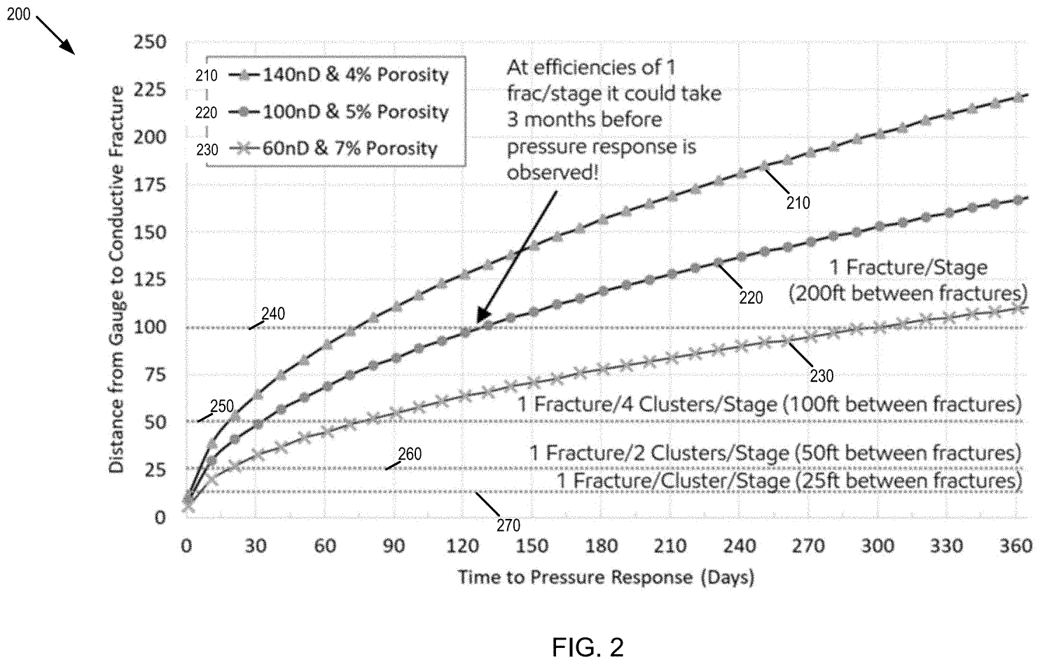

Once generated, the model may be used to calibrate for a given reservoir the optimal gauge resolution and placement. In particular, given the expected pressures at a distance to a conductive fracture and a time frame, the methodology may assess if a given configuration is likely to generate the required information in the desired turnaround time. See FIG. 2, discussed below.

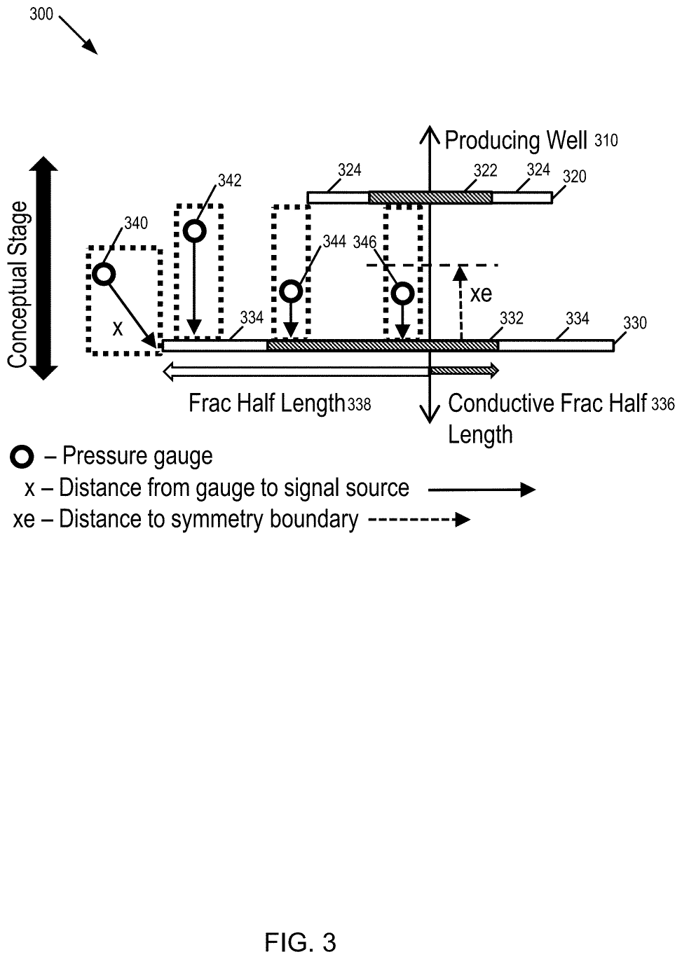

The analytical model may be on one or more variables. For example, independent variables in the analytical model may comprise (or consist of) any one, any combination, or all of: permeability of the reservoir matrix; porosity of the reservoir matrix; viscosity of the reservoir fluid; total compressibility of the system; fluid flux; or formation volume factor of the reservoir fluid. Dependent variables in the analytical model may comprise (or consist of) any one, any combination, or all of: distance to conductive fracture/symmetry boundary; superposition time, which may be calculated via the inverse problem algorithm. In one or some embodiments, the analytical model may consider uncertainty in the input given by a range (see FIG. 2, discussed below) or may use deterministic values when properties are known. In one or some embodiments, the pressure time series from the BHPs in the signal well and distributed gauges in the monitor well, such as illustrated in 1, may provide the required pressure data. Alternatively, data may be obtained from gauges placed in different wells and/or in neighborhood producing. As discussed further below, the analytical model may be used to analyze field data and may further be used with other independent techniques to detect and/or characterize potential fractures, such as by generating a view of fractures. See FIG. 3.

Referring back to the figures, FIG. 2 is a graph 200 of time to pressure response (in days) versus distance from gauge to conductive fracture indicative of a simplified analytical model-based gauge resolution requirements for a given completion efficiency. In particular, FIG. 2 is a characterization of the behavior of a part of the subsurface reflecting how quickly a pressure response is observed versus distance from the fracture. As shown in FIG. 2, the characteristics of the subsurface, such as the porosity and/or the permeability, dictate the speed at which the pressure response is observed. In one or some embodiments, the characteristics of the subsurface, such as the porosity and/or the permeability, may be estimated or determined based on reservoir modeling. Typically, the characteristics of the subsurface determined by reservoir modeling may be defined as a range of permeabilities (e.g., 60-140 nano Darcy (nD)) and porosities (e.g., 4-7%) or sets of values. Example values are illustrated in FIG. 2 as three curves corresponding to three different permeabilities and porosities, with curve 210 associated with permeability of 140 nD and 4% porosity, curve 220 associated with permeability of 100 nD and 5% porosity, and curve 230 associated with permeability of 60 nD and 7% porosity. Horizontal lines 240, 250, 260, 270 indicate the distance between fractures, with horizontal line 240 correlating to distance of the gauge to the conductive fracture being 100 ft, so that the distance between fractures (with the gauge at the midpoint) being 200 ft. Similarly, horizontal lines 250, 260, 270 have distances between fractures at 100 ft, 50 ft and 25 ft, respectively.

In one or some embodiments, a cluster may refer to a cluster of perforations. When fracking, perforation of the casing is performed using a number of “perfs”, with the number of perfs being called a cluster. In practice, the perfs represent the openings in which fluid is pushed through to hydraulically fracture. A number of clusters may then comprise a stage, with multiple stages being utilized along a well. As an analogy of a frac job to a tree, a perf is akin to a leaf, a cluster is akin to a branch, and a stage is akin a tree limb. Referring back to FIG. 2, graph 200 indicates 2 clusters/stage and 4 clusters/stage (e.g., in the analogy, 4 clusters/stage is akin to 4 branches on a tree limb).

The curves 210, 220, 230 are merely for purposes of illustration. In one or some embodiments, the arrival times measured may be used to determine with greater specificity the permeability and porosity of the subsurface.

FIG. 2 provides an operator with guidance as to configuring the gauges in the system. By way of example, if an operator seeks a pressure response within 90 days, and if the permeability/porosity is 100 nD/5%, curve 220 indicates that the pressure will travel no more than 80 ft within that time. In this regard, a worst case scenario (defined by the fracture being precisely in the middle of gauges that are spaced 160 ft apart) results in the pressure travelling within 90 days. This information may then be used to configure the monitor well (e.g., the slant or angle of the monitor well) such that the gauges may be positioned sufficiently apart so that the pressure transients arrive and interact with other fractures inside of the time frame for the assessment. In the event that a response time quicker than 90 days is desired, additional gauges may be used so that the pressure travels no more than 50 ft within a time period of 30 days. In this way, responsive to defining a time period of travel (e.g., 30 days or 90 days), responsive to determining the permeability/porosity (e.g., values or ranges such as illustrated in FIG. 2), and responsive to identifying the fractures/clusters per stage, the distance from gauge to conductive fracture may be determined and in turn the distance between gauges for configuring the system.

FIG. 3 is a second example of a schematic of a map view 300 of a 2 well system composed of a producing well 310 and a monitor well intersecting the fractured area, with a plurality of gauges 340, 342, 344, 346 at gauge locations. The map view 300 illustrates various distances, such as the distances to a respective fracture (x), such as fracture 320 or fracture 330, and the distance to the symmetry boundary (xe). Further, using the analytical model, the section(s) acting as conductive fracture(s), shown as 322 and 332, may be identified (with conductive fracture half-length 336 shown), and provide contrast to the section(s) acting as non-conductive fracture(s), shown as 324 and 334 (with the fracture half-length 338 shown).

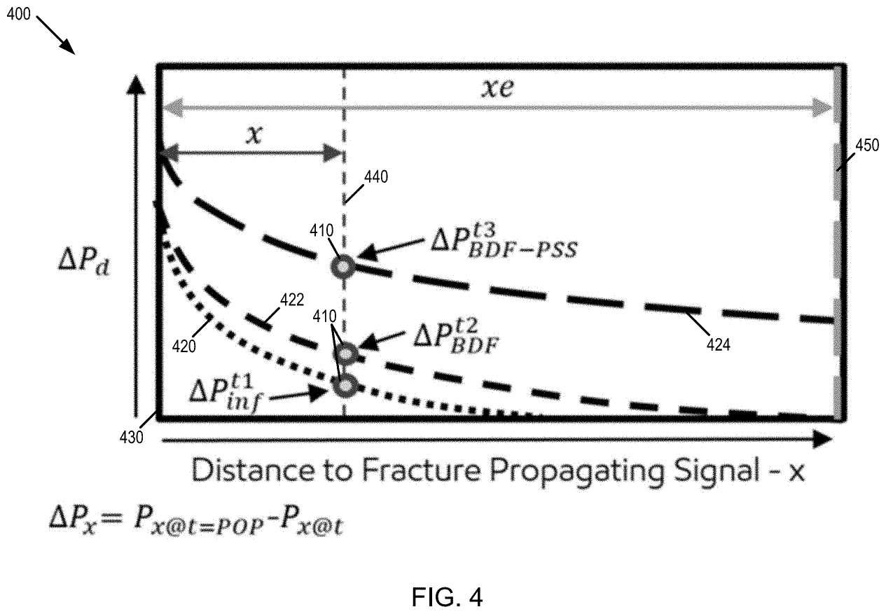

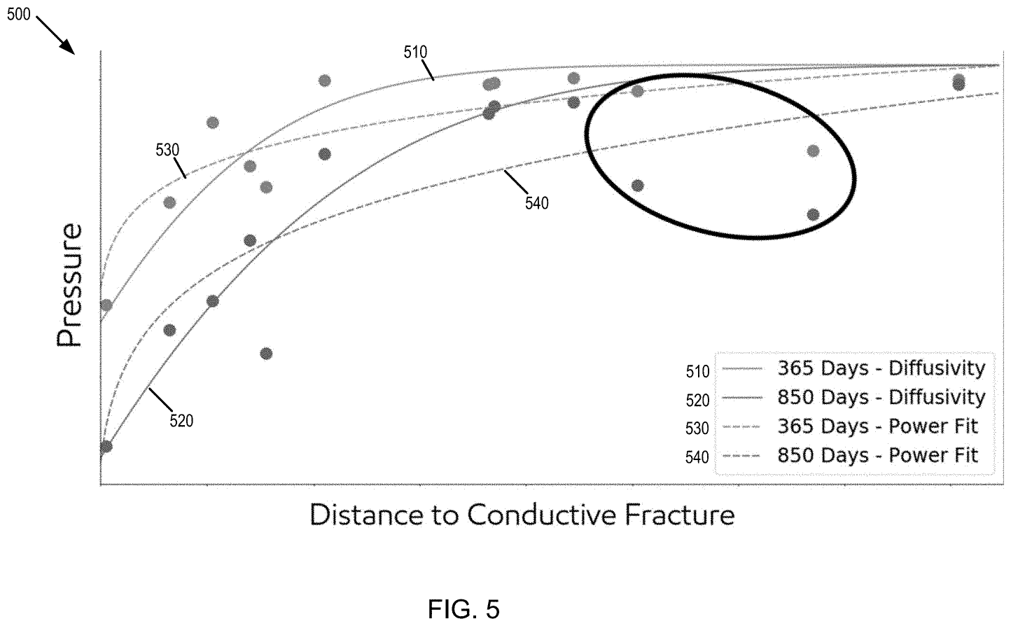

The analytical model may be applied in the analysis of various field data, such as illustrated in FIGS. 4 and 5, which illustrate matches to two sets of field data. Specifically, FIGS. 4 and 5 illustrate the output of the analytical model including: (1) pressure at a particular time (shown as dots 410) on the y-axis; (2) the calculated effective distance to a conductive fracture on the x-axis; and (3) the reservoir properties that result in the history matched pressure-time contours (curves 420, 422, 424).

FIG. 4 is an illustration 400 showing that the analytical model may map distances to conductive fractures with high accuracy, particularly that the pressure may be represented in field trials with properly incorporated flow regimes. In particular, various solutions may be used to the diffusivity equation for the analytical model, such as the following:

$$\frac{{\partial }^{2} {p}_{d}}{\partial {x}_{{d}^{2}}} = \frac{\partial {p}_{d}}{\partial {t}_{d}} \\ {p}_{d} ( {t}_{d} , {x}_{d} ) = \frac{\sqrt[2]{{t}_{d}}}{\sqrt{π}} {e}^{\frac{{x}_{d}^{2}}{4 {t}_{d}}} - {x}_{d} ercf ( η ) .$$

Error optimization function:

Obj(x_{i∈{1 . . . xe}},t_{j∈{1 . . . t}},k,phi,u,ct,f,B)=min(Σₓ_{_{i∈{1 . . . xe}|j∈(1 . . . t)}}NRMSE|Δp_{calc}(x,t)|).

In this way, the analytical model may be used to analyze field data and the results are consistent with independent techniques of detecting potential fractures generating a view of fractures, such as illustrated in FIG. 3.

Practically speaking, 430 may be viewed as the fracture face, with 450 being the symmetric middle between 2 fractures, with distance from gauge to signal source x being from 430 to 440 and distance to the symmetry boundary xe being from 430 to 450. Further, dots 410 may be measured pressured values at a given time (e.g., with multiple pressure gauges). In this regard, data is available regarding the pressure changes; however, other variables, such as the location of the pressure gauge relative to the fractures and the particular curve to fit the data, may be unknown or only known within a certain range. The pressure transient has traveled over time, such as t₁, t₂, and t₃, may be used as pressure signatures indicative of a history of pressure signatures, which may be matched to at least one curve in order to identify a solution (e.g., a hydraulic diffusivity). Specifically, different curves represent the pressure transient traveling over time, with curve 420 for t₁ representing the initial pressure differential, curve 422 for t₂ representing the pressure differential later in time, and curve 424 for t₃ representing the pressure differential still later in time. In this way, the pressure changes over time may be mapped and matched to existing curves for the time series, thereby determining the distance of the gauges to the fractures.

FIG. 5 is an illustration 500 of a second example output from an analytical diffusivity model using published data from a competitor pilot, with curves 510, 520, 530, 540.

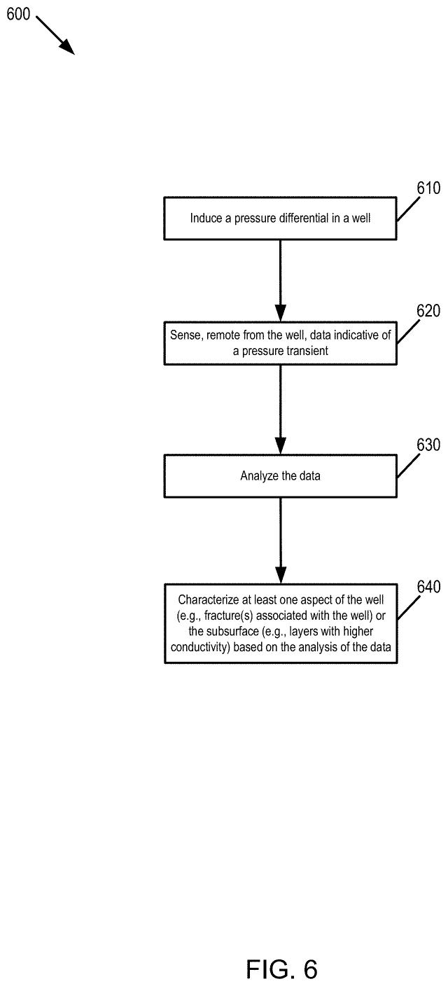

FIG. 6 is an example of a flow diagram 600 of obtaining data and generating an analytical model for predicting locations of high conductivity. At 610, a pressure differential is induced in at least a part of the well (such as a resulting pressure differential in the fracture). At 620, data indicative of the pressure transient is sensed remote from the well (e.g., at a pressure gauge in a monitor well). At 630, the data is analyzed. At 640, at least one aspect of the well, such as one or more fractures associated with the well or the subsurface, such as layers with higher conductivity, are characterized based on the analysis of the data. For example, the inverse problem may be solved in order to curve fit the data to the sense pressure in order to identify the distance to the conductive fractures, as discussed above.

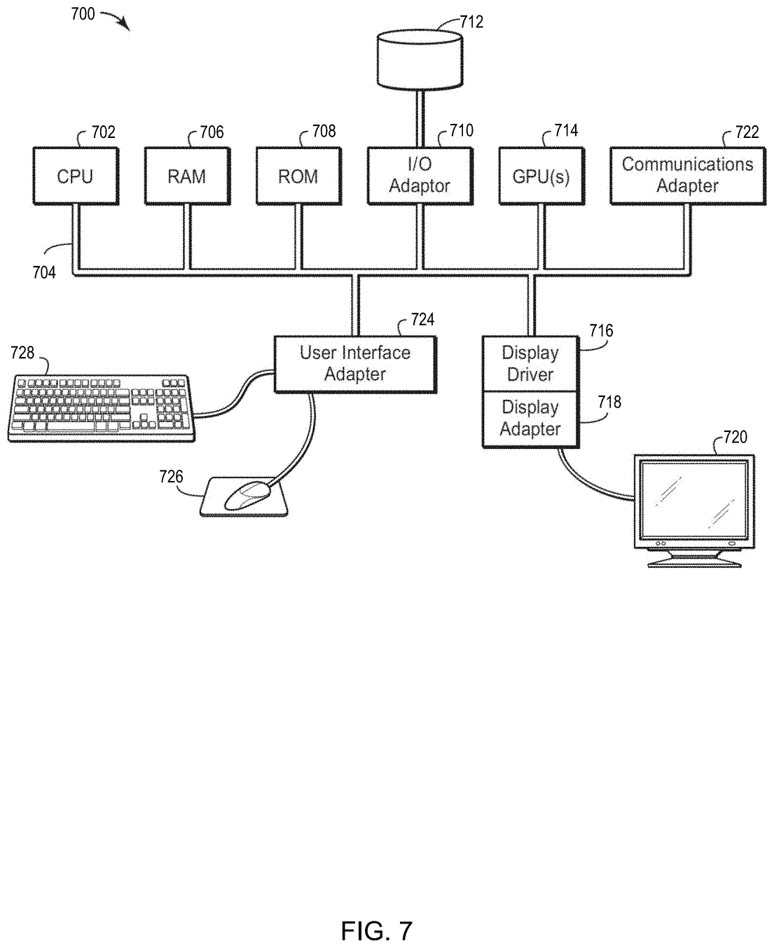

In all practical applications, the present technological advancement must be used in conjunction with a computer, programmed in accordance with the disclosures herein. For example, FIG. 7 is a diagram of an exemplary computer system 700 that may be utilized to implement methods described herein. A central processing unit (CPU) 702 is coupled to system bus 704. The CPU 702 may be any general-purpose CPU, although other types of architectures of CPU 702 (or other components of exemplary computer system 700) may be used as long as CPU 702 (and other components of computer system 700) supports the operations as described herein. Those of ordinary skill in the art will appreciate that, while only a single CPU 702 is shown in FIG. 7, additional CPUs may be present. Moreover, the computer system 700 may comprise a networked, multi-processor computer system that may include a hybrid parallel CPU/GPU system. The CPU 702 may execute the various logical instructions according to various teachings disclosed herein. For example, the CPU 702 may execute machine-level instructions for performing processing according to the operational flow described.

The computer system 700 may also include computer components such as non-transitory, computer-readable media. Examples of computer-readable media include computer-readable non-transitory storage media, such as a random-access memory (RAM) 706, which may be SRAM, DRAM, SDRAM, or the like. The computer system 700 may also include additional non-transitory, computer-readable storage media such as a read-only memory (ROM) 708, which may be PROM, EPROM, EEPROM, or the like. RAM 706 and ROM 708 hold user and system data and programs, as is known in the art. The computer system 700 may also include an input/output (I/O) adapter 710, a graphics processing unit (GPU) 714, a communications adapter 722, a user interface adapter 724, a display driver 716, and a display adapter 718.

The I/O adapter 710 may connect additional non-transitory, computer-readable media such as storage device(s) 712, including, for example, a hard drive, a compact disc (CD) drive, a floppy disk drive, a tape drive, and the like to computer system 700. The storage device(s) may be used when RAM 706 is insufficient for the memory requirements associated with storing data for operations of the present techniques. The data storage of the computer system 700 may be used for storing information and/or other data used or generated as disclosed herein. For example, storage device(s) 712 may be used to store configuration information or additional plug-ins in accordance with the present techniques. Further, user interface adapter 724 couples user input devices, such as a keyboard 728, a pointing device 726 and/or output devices to the computer system 700. The display adapter 718 is driven by the CPU 702 to control the display on a display device 720 to, for example, present information to the user such as subsurface images generated according to methods described herein.

The architecture of computer system 700 may be varied as desired. For example, any suitable processor-based device may be used, including without limitation personal computers, laptop computers, computer workstations, and multi-processor servers. Moreover, the present technological advancement may be implemented on application specific integrated circuits (ASICs) or very large scale integrated (VLSI) circuits. In fact, persons of ordinary skill in the art may use any number of suitable hardware structures capable of executing logical operations according to the present technological advancement. The term “processing circuit” encompasses a hardware processor (such as those found in the hardware devices noted above), ASICs, and VLSI circuits. Input data to the computer system 700 may include various plug-ins and library files. Input data may additionally include configuration information.

Preferably, the computer is a high-performance computer (HPC), known to those skilled in the art. Such high-performance computers typically involve clusters of nodes, each node having multiple CPU's and computer memory that allow parallel computation. The models may be visualized and edited using any interactive visualization programs and associated hardware, such as monitors and projectors. The architecture of system may vary and may be composed of any number of suitable hardware structures capable of executing logical operations and displaying the output according to the present technological advancement. Those of ordinary skill in the art are aware of suitable supercomputers available from Cray or IBM or other cloud computing based vendors such as Microsoft Amazon.

The above-described techniques, and/or systems implementing such techniques, can further include hydrocarbon management based at least in part upon the above techniques, including using the device in one or more aspects of hydrocarbon management. For instance, methods according to various embodiments may include managing hydrocarbons based at least in part upon the device and data representations constructed according to the above-described methods. In particular, such methods may use the device to evaluate various welds in the context of drilling a well.

It is intended that the foregoing detailed description be understood as an illustration of selected forms that the invention can take and not as a definition of the invention. It is only the following claims, including all equivalents which are intended to define the scope of the claimed invention. Further, it should be noted that any aspect of any of the preferred embodiments described herein may be used alone or in combination with one another. Finally, persons skilled in the art will readily recognize that in preferred implementation, some, or all of the steps in the disclosed method are performed using a computer so that the methodology is computer implemented. In such cases, the resulting physical properties model may be downloaded or saved to computer storage.

The following example embodiments of the invention are also disclosed.

Embodiment 1: A computer-implemented method for characterizing at least one of a part of a well or a part of a subsurface, the method comprising:

inducing one or more pressure changes at or in at least one well;

sensing data, exterior to the at least one well using at least one sensor, indicative of an effect of the one or more pressure changes;

generating, using the data, information indicative of one or more locations where the effect of the one or more pressure changes at the at least one well are reflected quicker than in a surrounding reservoir in order to characterize the at least one of a part of the at least one well or the part of the subsurface; and

using the information for hydrocarbon development.

Embodiment 2: The method of embodiment 1:

wherein the one or more pressure changes induce one or more fracture pressure changes in one or more fractures associated with the at least one well;

wherein the data sensed is using one or more sensors positioned or associated with a monitoring well; and

wherein the information indicative of the one or more locations where the effect of the one or more pressure changes are reflected quicker than in the surrounding reservoir are used to characterize at least one aspect of the one or more fractures.

Embodiment 3: The method of embodiments 1 or 2:

wherein the at least one aspect of the one or more fractures comprises conductivity of the one or more fractures.

Embodiment 4: The method of embodiments 1-3:

wherein the conductivity above a predetermined amount is indicative that fluid is flowing through the one or more fractures.

Embodiment 5: The method of embodiments 1-4:

wherein the at least one aspect of the one or more fractures comprises one or both of a location or a length of the conductivity of the one or more fractures.

Embodiment 6: The method of embodiments 1-5:

wherein one or more sensors comprise one or more gauges to sense the one or more pressure changes; and

wherein the at least one aspect of the one or more fractures comprises the location of one or more conductive fractures relative to the one or more gauges.

Embodiment 7: The method of embodiments 1-6:

wherein the data sensed is using one or more sensors positioned or associated with a monitoring well; and

wherein the information indicative of the one or more locations where the effect of the one or more pressure changes are reflected quicker than in the surrounding reservoir are used to characterize at least one aspect of the subsurface.

Embodiment 8: The method of embodiments 1-7:

wherein the at least one aspect of the subsurface characterized comprises conductivity of one or more locations in the subsurface.

Embodiment 9: The method of embodiments 1-8:

wherein the conductivity of the one or more locations in the subsurface is greater than surrounding rock in the subsurface.

Embodiment 10: The method of embodiments 1-9:

wherein inducing the one or more pressure changes is at or in an injector well;

further comprising training an analytical model using the data; and

wherein the analytical model generates the information indicative of the one or more locations where the effect of the one or more pressure changes at the injector well are reflected quicker than in the surrounding reservoir.

Embodiment 11: The method of embodiments 1-10:

wherein the analytical model generates the information indicative of the one or more locations where the effect of the one or more pressure changes at the injector well are reflected quicker than in the surrounding reservoir by analyzing observed pressure variations at one or more pressure gauges positioned in a monitoring well.

Embodiment 12: The method of embodiments 1-11:

wherein the analytical model performs a nonlinear mathematical optimization to pressure time series obtained at the one or more pressure gauges by utilizing at least one of spatial distance from conductive fractures or reservoir input as independent variables.

Embodiment 13: The method of embodiments 1-12:

wherein the analytical model iteratively minimizes an error reduction objective function to match pressure and distances to conductive fractures with a data set used for the match.

Embodiment 14: The method of embodiments 1-13:

wherein the analytical model determines one or more conductive fractures in the at least one well; and

wherein the analytical model generates a spatially-distributed view of the one or more conductive fractures.

Embodiment 15: The method of embodiments 1-14:

wherein the one or more conductive fractures are used for analysis of or optimization of a hydrocarbon development of the subsurface.

Embodiment 16: The method of embodiments 1-15:

wherein the information is indicative of conductive fractures in the subsurface; and

wherein using the information for hydrocarbon development comprises modifying one or both of fracture completion or well spacing based on the information indicative of the conductive fractures in the subsurface.

Embodiment 17: The method of embodiments 1-16:

wherein the sensed data comprises pressure time series sensed at a plurality of gauges;

further comprising performing reservoir simulation in order to determine one or both of porosity or permeability of the subsurface; and

wherein characterizing the at least one of a part of the at least one well or the part of the subsurface comprises:
curve fitting, using the one or both of porosity or permeability of the subsurface, the pressure time series in order to generate the information indicative of one or more locations of conductive fractures in the subsurface.

Embodiment 18: The method of embodiments 1-17:

further comprising generating an output indicative of the information indicative of one or more locations of conductive fractures in the subsurface; and

wherein using the information for hydrocarbon development comprises modifying one or both of fracture completion or well spacing based on the information indicative of the conductive fractures in the subsurface.

Embodiment 19: A system comprising:

a processor; and

a non-transitory machine-readable medium comprising instructions that, when executed by the processor, cause a computing system to perform a method according to any of embodiments 1-18.

Embodiment 20: A non-transitory machine-readable medium comprising instructions that, when executed by a processor, cause a computing system to perform a method according to any of embodiments 1-18.

Embodiment 21: A computer-implemented method for positioning one or more sensors in a monitoring well in a subsurface, the method comprising:

inducing one or more pressure changes at or in at least one well;

sensing data, exterior to the at least one well using at least one sensor, indicative of an effect of the one or more pressure changes;

generating, using the data, information indicative of one or more locations where the effect of the one or more pressure changes at the at least one well are reflected quicker than in a surrounding reservoir in order to characterize the at least one of a part of the at least one well or the part of the subsurface;

determining, based on the information, one or more positions for the one or more sensors; and

positioning, based on the one or more positions, the one or more sensors in the monitoring well.

Embodiment 22: The method of embodiment 21:

wherein determining the one or more positions comprises:

determining a time period in which to receive pressure data from the one or more sensors; and

determining, based on the time period in which to receive pressure data from the one or more sensors and the information, the one or more positions of the one or more sensors.

Embodiment 23: A system comprising:

a processor; and

a non-transitory machine-readable medium comprising instructions that, when executed by the processor, cause a computing system to perform a method according to any of embodiments 21-22.

Embodiment 24: A non-transitory machine-readable medium comprising instructions that, when executed by a processor, cause a computing system to perform a method according to any of embodiments 21-22.

What is claimed is:

1. A computer-implemented method for characterizing at least one of a part of a well or a part of a subsurface, the method comprising:
inducing one or more pressure changes at or in at least one well;
sensing data, exterior to the at least one well using at least one sensor, indicative of an effect of the one or more pressure changes;
generating, using the data, information indicative of one or more locations where the effect of the one or more pressure changes at the at least one well are reflected quicker than in a surrounding reservoir in order to characterize the at least one of a part of the at least one well or the part of the subsurface; and
using the information for hydrocarbon development.

2. The method of claim 1, wherein the one or more pressure changes induce one or more fracture pressure changes in one or more fractures associated with the at least one well;
wherein the data sensed is using one or more sensors positioned or associated with a monitoring well; and
wherein the information indicative of the one or more locations where the effect of the one or more pressure changes are reflected quicker than in the surrounding reservoir are used to characterize at least one aspect of the one or more fractures.

3. The method of claim 2, wherein the at least one aspect of the one or more fractures comprises conductivity of the one or more fractures.

4. The method of claim 3, wherein the conductivity above a predetermined amount is indicative that fluid is flowing through the one or more fractures.

5. The method of claim 3, wherein the at least one aspect of the one or more fractures comprises one or both of a location or a length of the conductivity of the one or more fractures.

6. The method of claim 5, wherein one or more sensors comprise one or more gauges to sense the one or more pressure changes; and
wherein the at least one aspect of the one or more fractures comprises the location of one or more conductive fractures relative to the one or more gauges.

7. The method of claim 1, wherein the data sensed is using one or more sensors positioned or associated with a monitoring well; and
wherein the information indicative of the one or more locations where the effect of the one or more pressure changes are reflected quicker than in the surrounding reservoir are used to characterize at least one aspect of the subsurface.

8. The method of claim 7, wherein the at least one aspect of the subsurface characterized comprises conductivity of one or more locations in the subsurface.

9. The method of claim 8, wherein the conductivity of the one or more locations in the subsurface is greater than surrounding rock in the subsurface.

10. The method of claim 1, wherein inducing the one or more pressure changes is at or in an injector well;
further comprising training an analytical model using the data; and
wherein the analytical model generates the information indicative of the one or more locations where the effect of the one or more pressure changes at the injector well are reflected quicker than in the surrounding reservoir.

11. The method of claim 10, wherein the analytical model generates the information indicative of the one or more locations where the effect of the one or more pressure changes at the injector well are reflected quicker than in the surrounding reservoir by analyzing observed pressure variations at one or more pressure gauges positioned in a monitoring well.

12. The method of claim 11, wherein the analytical model performs a nonlinear mathematical optimization to pressure time series obtained at the one or more pressure gauges by utilizing at least one of spatial distance from conductive fractures or reservoir input as independent variables.

13. The method of claim 12, wherein the analytical model iteratively minimizes an error reduction objective function to match pressure and distances to conductive fractures with a data set used for the match.

14. The method of claim 11, wherein the analytical model determines one or more conductive fractures in the at least one well; and
wherein the analytical model generates a spatially-distributed view of the one or more conductive fractures.

15. The method of claim 14, wherein the one or more conductive fractures are used for analysis of or optimization of a hydrocarbon development of the subsurface.

16. The method of claim 1, wherein the information is indicative of conductive fractures in the subsurface; and
wherein using the information for hydrocarbon development comprises modifying one or both of fracture completion or well spacing based on the information indicative of the conductive fractures in the subsurface.

17. The method of claim 1, wherein the sensed data comprises pressure time series sensed at a plurality of gauges;
further comprising performing reservoir simulation in order to determine one or both of porosity or permeability of the subsurface; and
wherein characterizing the at least one of a part of the at least one well or the part of the subsurface comprises:
curve fitting, using the one or both of porosity or permeability of the subsurface, the pressure time series in order to generate the information indicative of one or more locations of conductive fractures in the subsurface.

18. The method of claim 17, further comprising generating an output indicative of the information indicative of one or more locations of conductive fractures in the subsurface; and
wherein using the information for hydrocarbon development comprises modifying one or both of fracture completion or well spacing based on the information indicative of the conductive fractures in the subsurface.

19. A computer-implemented method for positioning one or more sensors in a monitoring well in a subsurface, the method comprising:
inducing one or more pressure changes at or in at least one well;
sensing data, exterior to the at least one well using at least one sensor, indicative of an effect of the one or more pressure changes;
generating, using the data, information indicative of one or more locations where the effect of the one or more pressure changes at the at least one well are reflected quicker than in a surrounding reservoir in order to characterize the at least one of a part of the at least one well or the part of the subsurface;
determining, based on the information, one or more positions for the one or more sensors; and
positioning, based on the one or more positions, the one or more sensors in the monitoring well.

20. The method of claim 19, wherein determining the one or more positions comprises:
determining a time period in which to receive pressure data from the one or more sensors; and
determining, based on the time period in which to receive pressure data from the one or more sensors and the information, the one or more positions of the one or more sensors.
